(19) United States
(12) Patent Application Publication
(10) Pub. No.: US 2005/0084613 A1
(43) Pub. Date: Apr. 21, 2005

(54) Sub-micron-scale patterning method and system

(76) Inventors: Jian wang, Orefield, PA (US); Lei Chen, Princeton, NJ (US); Howard Lee, Princeton, NJ (US)

Correspondence Address: REED SMITH LLP, 2500 ONE LIBERTY PLACE, 1650 MARKET STREET, PHILADELPHIA, PA, 19103, US

(21) Appl. No.: 10/922,222

(22) Filed: Aug. 19, 2004

Related U.S. Application Data
(60) Provisional application No. 60/496,193, filed on Aug. 19, 2003.

(51) Int. Cl. B05D 1/32

(52) U.S. Cl. 427/282; 427/372.2

(57) ABSTRACT

A method for replicating a nanopattern is disclosed. This method includes identifying a substrate; coating a surface of the substrate with a liquid layer; positioning a mold having a plurality of recesses defining a negative of the nanopattern in sufficient proximity with the coated liquid layer to cause the liquid layer to self-fill at least a portion of the plurality of recesses of the mold; and, chemically transforming the liquid layer to enable the transformed film to substantially retain the nanopattern.

This application claims priority of U.S. Patent Application Ser. No. 60/496,193, entitled SUB-MICRON-SCALE PATTERNING METHOD AND SYSTEM, filed Aug. 19, 2003, the entire disclosure of which is hereby incorporated by reference as if being set forth in its entirety herein.

### FIELD OF THE INVENTION

### BACKGROUND OF THE INVENTION

In fabricating semiconductor integrated electrical circuits, integrated optical, magnetic and mechanical circuits, and other similarly produced devices, one method of production involves molding technology, such as embossing or nanoimprinting, step and flash imprint, and mold assisted nanolithography. While each of these methods differs in the specific method and steps, or physical principle, the methods all suffer from drawbacks in forming nano-scale patterns. Each may be generally classified as including lithography.

Embossing involves pressing a stamp into a polymer heated just above its transition temperature. While embossing generally produces a uniform pattern and provides relatively easy mold separation, embossing generally has several drawbacks with respect to the creation of nano-scaled devices. Embossing occurs at a high or at least elevated temperature, involves high pressure, acts on bulk structures, and results in limited nano-scale pattern transfer. Each of these drawbacks lessens the usefulness of embossing for creation nano-scale patterns.

Injection molding, generally, involves melting a desired polymer and forcing the melted polymer into the mold. While injection molding produces uniform patterns and provides easy mold separation, injection molding suffers from many drawbacks in creating nano-scaled device. For example, injection molding requires elevated temperatures, high pressure, bulk structures, and results in limited pattern transfer at the nano-scale. These drawbacks reduce the usefulness of injection molding in creating nano-scale patterns.

Nanoimprint lithography may generally be described as a lithographic method designed for creating ultra-fine patterns in a thin film coated on a surface. The process involves a mold being pressed into a thin film applied to a substrate, thereby creating at least one corresponding recess in the thin film. The patterns in the thin film are transferred into the substrate using a technique such as reactive ion etching (RIE) or plasma etching. While nanoimprint lithography may produce a uniform pattern of controllable thickness on the nano-scale level in a single layer, nanoimprint requires elevated temperatures and a high pressure. Thus molding equipment capable of applying the pressures and elevated temperatures in a suitable manner may be required.

Step and flash imprint generally utilizes a transparent template and a ultraviolet radiation curable material to allow pattern replication at room temperature and low pressures. This technology may provide for improved template-substrate alignment, as well as reduced magnification and distortion errors. While step and flash imprinting may be performed at room temperatures and provide easy mold separation, step and flash imprint suffers from many drawbacks with respect to nano-scale patterns. Step and flash imprint requires low to medium pressure levels and often produces a non-uniform pattern. Further, step and flash imprint operates on an imaging or transfer layer. The non-uniformity of the pattern may be sufficient to render step and flash imprinting as inapplicable for many nano-scale purposes.

Mold assisted nanolithography may be performed at room temperature with low or medium pressure with the ability to transfer nano-scale patterns to a single layer structure. But, this technology suffers from the drawback that pattern uniformity is often lacking. The non-uniform pattern is often undesirable and limits the usefulness of mold assisted nanolithography for many nano-scale purposes.

### SUMMARY OF THE INVENTION

A method for replicating a nanopattern is disclosed. This method includes identifying a substrate; coating a surface of the substrate with a liquid layer with controlled thickness and good film uniformity; positioning a mold having a plurality of recesses defining a negative of the nanopattern in sufficient proximity with the coated liquid layer to cause the liquid layer to self-fill at least a portion of the plurality of recesses of the mold; and, chemically transforming the liquid layer to enable the transformed film to substantially retain the nanopattern.

Further disclosed is a liquid layer composition. This fluid film composition includes a polymerizable composite comprising a polymerizable compound and a photointiator, wherein the composition is a flowable solution for spin coating a surface of a substrate and wherein the composition is susceptible to transformation into a material for maintaining a pattern shape of a mold.

### BRIEF DESCRIPTION OF THE FIGURES

Understanding of the present invention may be facilitated by consideration of the following detailed description of the preferred embodiments of the present invention taken in conjunction with the accompanying drawings, in which like numerals refer to like parts and:

FIG. 1 illustrates a flow diagram according to an aspect of the present invention;

FIG. 2 illustrates a diagrammatical representation of processing consistent with the flow diagram of FIG. 1;

FIG. 3 illustrates a pictorial representation of magnified images of nano-gratings formed consistently with the flow diagram of FIG. 1; and

FIG. 4 illustrates a pictorial representation of the interfacial and capillary forces utilized according to an aspect of the present invention.

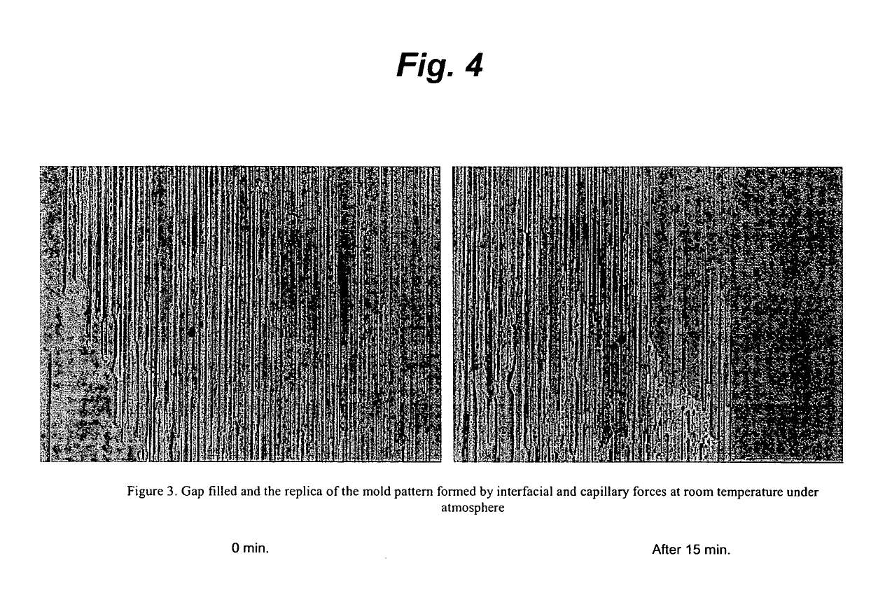

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical lithographic processes and methods of manufacturing the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

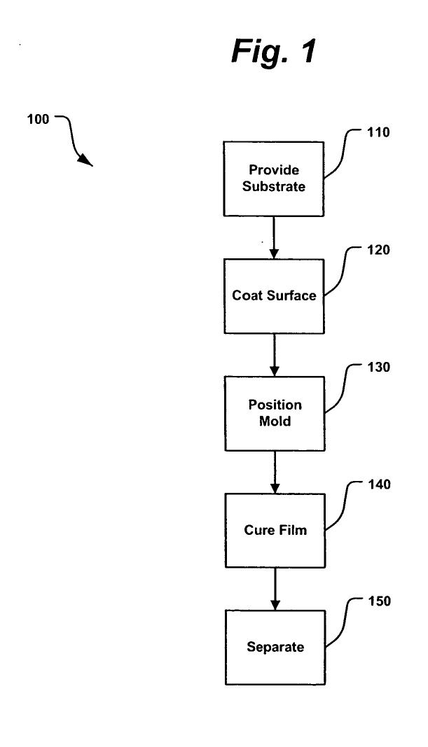

Referring now to FIG. 1, there is shown a method 100 for forming a pattern according to an aspect of the present invention. A pattern formed according to the present invention may be used as a lithography mask. Further, a pattern formed according to the present invention may be used as a device, or portion thereof, such as a light emitting device like a light emitting diode (LED) or opto-electronic device by way of non-limiting example only. For non-limiting purposes of completeness only, and as will be understood by those possessing an ordinary skill in the pertinent arts, one type of LED that may be formed is an organic LED (OLED). Further, opto-electronic devices generally include devices that generate and/or respond to light. Nonetheless, the method of use of a pattern formed according to the present invention is not intended to limit the present invention.

Method 100 may generally include identifying a substrate 110, coating the substrate with a liquid layer 120, positioning a mold including a pattern in proximity to the liquid layer 130 to permit the liquid layer to conform to interstices in the pattern, chemically transforming the liquid layer 140 such that it retains the conformed pattern, and separating the chemically-transformed, shape retaining film from the mold 150.

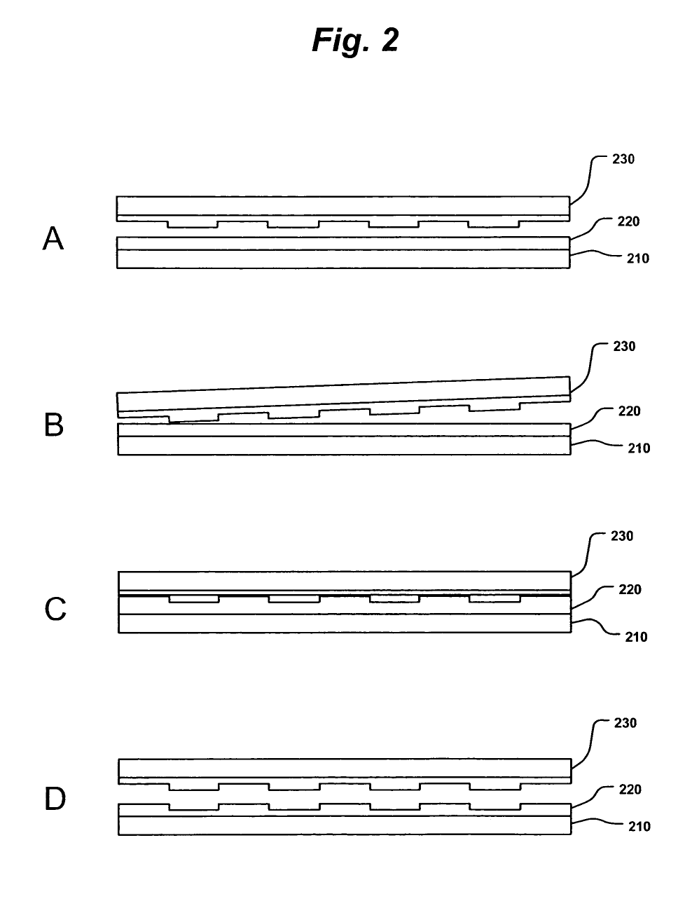

Referring now also to FIG. 2, identifying 110 may include selecting a substrate 210 that is compatible with a desired application, such as telecommunications, for example. In this regard, substrate 210 may be selected according to desired optical, mechanical, electrical, business (such as cost) or chemical properties, or a combination of these properties. An identified substrate may take the form of any of a number of different materials related to the desired application, such as semiconductors, dielectrics, metals and plastics, and more specifically polymers, silicon, glass, silicon dioxide and gallium arsenide, by way of non-limiting example only. Further, an identified substrate 210 may take the form of a composite substrate, such as InP, LiNbO₃, garnet, SiO₂/Si, or Si₃Nₓ/glass substrate, and may include a single or multiple layers, by way of non-limiting example only. Further, the identified substrate 210 may be pre-patterned or pre-processed with features, such as nano-structure or micro-structure patterns that may be formed in accordance with the present invention, or otherwise, by way of non-limiting example only.

For example, a four-inch diameter BK7 glass wafer with multiple dielectric thin films approximately 500 microns in total thickness may be identified or selected 110 as substrate 210. Suitable thin films for use with the BK7 glass wafer may include Si₃Nₓ, HFO₂, SiO₂ or Ta₂O₅. For example, a 500 nm to 1000 nm SiO₂ layer may be provided on top of a 50 nm to 100 nm HFO₂ layer, on top of a 100 nm to 300 nm SiO₂ layer, on top of a 50 nm to 200 nm HFO₂ layer, which is on top of 0.5 mm thick BK7 glass. On the other side, a 50 nm to 200 nm SiO₂ layer may be provided on top of a 50 nm to 200 nm HFO₂ layer, on top of the 0.5 mm thick BK7 glass. By way of further non-limiting example, a 500 nm to 1000 nm Silicon Nitride layer may be provided on top of a 50 nm to 200 nm HFO₂ layer, on top of a 50 nm to 200 nm SiO₂ layer, on top of a 50 nm to 200 nm HFO₂ layer, which is on top of a 0.43 mm thick BK7 glass substrate. By way of further non-limiting example, a 500 nm to 1000 nm Silicon Nitride layer may be provided on top of a 50 nm to 150 nm Al₂O₃ layer, which is on top of a 430 micron thick Ohara glass substrate. On the other side, a 100 nm to 200 nm SiO2 may be provided on top of a 30 nm to 100 nm HFO2, which is on top of the 430 micron Ohara glass substrate. A further non-limiting example, a 50 nm to 250 nm Aluminum layer may be provided on top of a 10 nm to 50 nm SiO2 layer, which is on top of a 500 micron thick Polycarbonate (PC) or Polyimide plastic substrate.

Substrate 210 may be transparent, translucent or opaque to radiation, which radiation may optionally be used to aid in chemical transformation of the liquid layer into a material suitable for maintaining a patterned shape.

Still referring to FIGS. 1 and 2, substrate 210 may be coated 120 with a chemically transformable liquid composition layer 220, or liquid layer, using a suitable method known to those possessing an ordinary skill in the pertinent arts. For example, liquid layer coating 220 may be spin coated onto substrate 210. By way of non-limiting example only, spin-coating may generally involve depositing a certain amount (such as several mL) of the thin film fluid near the center of the substrate. For example, about 1-5 mL of thin film fluid may be deposited, poured or dropped on a 4 inch wafer substrate. The deposited fluid may generally be permitted to spread until it covers a threshold amount, such as a majority, of the substrate or portion of the substrate to be used for patterning. The substrate may then be accelerated such that centrifugal forces serve to further spread and uniformly coat the substrate with the fluid. The final thickness of the liquid film may be consistent with conventional well understood spin coating techniques and be a function of certain variables, such as the fluid solution viscosity and concentration, spin speed and acceleration rate, and surface tension for example. For example, the spin coating may include accelerating the substrate to a speed of about 1000-4000 rpm and held there for about 30-60 seconds.

Accordingly, the substrate 210 may be coated to a thickness of approximately 50 nm-250 nm and a uniformity of better than but not limited approximately ±10 nm or 3% of the film thickness. The liquid layer coating 220 may reduce surface imperfections in substrate 210 being coated, thereby resulting in an improved flatness or roughness of the substrate/liquid layer coated composite structure. Alternatively, liquid layer coating 220 may be applied 120 at a certain thickness to substrate 210 such that some non-planaralities, imperfections or undulations in the surface of substrate 210 carry through the liquid layer, and remain in the surface of liquid layer 220.

According to an aspect of the present invention, the material used for the liquid layer preferably has certain properties. For example, it is preferably spin-coatable with controlled thickness and uniformity. Yet, it is further desirable that the fluid have suitable properties such that once it has been spin-coated onto a substrate it remains positionally stable there. To achieve such, the fluid may have an initial viscosity of about 0.001 cps to 1,000 cps at room temperature. After it has been spin coated, the material may be treated, such as by heating it sufficiently to drive off a component such as a solvent. It may thereafter have a viscosity of about 0.01 cps to 10,000 cps at room temperature. Such a viscosity may also facilitate self-conforming of the fluid to interstices of the mold, as is discussed in more detail below. Further, it may be desirable for the material to exhibit certain release characteristics associated with the mold and energy initiator, such as photo initiator, and other additives, such as photosensitizer, compatibilizer, stabilizer, viscosity controller etc. The additives, for example, may constitute 0-70% in the formula.

According to an aspect of the present invention, the use of silicon containing composites in the liquid layer may be reduced. This may advantageously render the method of the present invention, and interim products according to an aspect of the present invention, oxygen etch compliant. As will be readily understood by those possessing an ordinary skill in the pertinent arts, oxygen etching may be preferable to other forms of etching because it does not etch the substrate normally and is relatively safe and easy to use. By way of further non-limiting explanation only, when composites contain enough silicon, oxygen etching is generally realized to be inapplicable, and therefore other types of etching are often performed, involving the use of more hazardous chemicals, such a CF₄ and CHF₃ for example. That being said, silicon containing composites may be used in the liquid layer, if desired.

According to an aspect of the present invention, a liquid layer 220, which is a type of composition that is capable of transformation, with or without a physical treatment, into a polymer unit is provided. According to an aspect of the invention, the liquid layer 220 has a polymerizable composite so that the liquid layer 220 may be polymerized to retain the mold shape. Thus, in this aspect, it may be necessary to use a polymerizable compound or precursor of a polymer as part of the polymerizable composite of a liquid layer composition. For example, polymerizable monomers or oligomers, or a combination thereof, can be used as building blocks so that a homopolymer or a copolymer is obtained. There are a great number of polymerizable compounds known to one skilled in the art. These include, for example, organic materials (or composites) such as epoxy, methyl acrylate, acrylamide, acrylic acid, vinyl, ketene acetyl groups containing monomers, oligomers and inorganic composites such as silicon, aluminum and other metallic or semi-metallic composites. A suitable polymerizable composite may include at least one polymerizable compound or precursor and optionally a diluent and/or a solvent. A diluent is not the same as a solvent for purposes of this invention. Diluent as used herein refers to one of the reactive components which is one of the components and forms part of the final film. Solvent is not intended to be part of the final film. The solvent may be used to control the viscosity of the liquid layer composition and the use of a solvent in the final composition is optional depending on the coating process. For example, solvent may be needed to modulate the viscosity of a composition used for spin coating a substrate. Typical solvents that may be use include toluene, dimethyl formamide, chlorobenzene, xylene, dimethyl sulfoxide (DMSO), dimethyl formamide, dimethyl acetamide, dioxane, tetrahydrofuran (THF), methylene chloride, ethylene chloride, carbon tetrachloride, chloroform, lower alkyl ethers such diethyl ether and methyl ethyl ether, hexane, cyclohexane, benzene, acetone, ethyl acetate, and the like. The boiling a solvent or solvent mixture can be, for example, below 200 C. Selection of suitable solvents for a given system will be within the skill in the art and/or in view of the present disclosure.

Thus, a composition of the liquid layer in its simplest form includes a polymerizable composite (e.g., a oligomer or a monomer). For purposes of convenience, the polymerizable composite is referred to herein as a first part of the liquid layer composition of the invention. Other parts (or materials) such as, for example, second part, third part, fourth part and so on may optionally be added as part of the liquid layer composition so long as such additives do not significantly detract from the liquid layer's ability to form a polymer unit. Examples of the other parts or additives may include at least one photo-initiator and such other additives, an internal release agent and lubricants, for example.

Thus, by way of non-limiting example only, a first part of liquid layer 220 may include monomer or oligomer resins, including methyl acrylates and epoxies with mono or multi functionality, polyether, polyester, polysiloxane, and polyurethane of different molecular weights. For example, molecular weights may range from 100 to 10,000 weight average molecular weight.

The flowability of the fluid used for spin-coating a surface may depend on the components of the composition, the chemical structure of the components and the molecular weight of the components. In the composition, viscosity controllers, such as organic plasticizers or polymeric compounds may be incorporated to control the flowability. Other factors such as the flexibility of the backbone and the interaction between the backbone, the graft degree or functionality of the backbone, the chemical structure of the end reactive groups may be taken into account in adjusting the flowability. A fluid thin composition of the present invention having an initial viscosity of up to about 100 cps at room temperature is flowable for spin coating a surface.

By way of non-limiting example only, such a first part may include, aliphatic allyl urethane, nonvolatile materials, aromatic acid methacrylate, aromatic acrylic ester, acrylated polyester oligomer, acrylate monomer, polyethylene glycol dimethacrylate, lauryl methacrylate, aliphatic diacrylate, trifunctional acid ester or epoxy resin.

A second part of liquid layer 220 may include photo-initiators such as free radical or cationic species and/or photosensitizer Free-radical photoinitiators may include acetophenones, aryl glyoxalates, acylphosphine oxides, benzoin ethers, benzil ketals, thioxanthones, chloroalkyltriazines, triacylimidazoles, pyrylium compounds, sulfonium and iodonium salts, mercapto compounds, quinones, azo compounds, organic peroxides, and mixtures thereof. Cationic photoinitiators may include metallocene salts having an onium cation and a halogen-containing complex anion of a metal or metalloid as well as iodonium salts and sulfonium salts, metallocene salts having an organometallic complex cation and a halogen-containing complex anion of a metal or metalloid. Mixtures of photoinitiators may also be useful. A third part of fluid film 220 may include a viscosity controller. By way of non-limiting example, such a plasticizer may include butyl octyl phthalate, dicapryl phthalate, dicyclohexyl phthalate, diisooctyl phthalate, dimethyl sebacate and polymeric plasticizer or polymer.

A fourth part of fluid film 220 may include other materials to add certain characteristics to liquid layer 220 as desired or needed, such as, internal release agents, compatibilizer, coupling agent, lubricants and other stabilizers. By way of non-limiting example, such other materials may include a fluorinated or siloxane based structure.

A specific liquid layer 220 may include elements selected from those discussed above with respect to parts one through four. Specifically, by way of non-limiting example, the liquid layer 220 may include at least one element selected from the first part and at least one element selected from the second part. For example, the fluid film may take the form of 0.90-0.99 parts of the first part and 0.1-0.01 parts of the second part. The liquid layer may include at least one element selected from the first part, at least one element selected from the second part and at least one element selected from the third part. For example, the fluid film may take the form of 0.50-0.99 parts of the first part, 0.1-0.01 parts of the second part and 0.0-0.5 parts of the third part. Or, the fluid film may include at least one element selected from the first part, at least one element selected from the second part, at least one element selected from the third part and at least one element selected from the fourth part. For example, the fluid film may take the form of 0.50-0.99 parts of the first part, 0.1-0.01 parts of the second part, 0.0-0.50 parts of the third part and 0.1-0.01 parts of the fourth part.

By way of further example, thermal polymerization and photoinitiated polymerization generally produce chain growth or crosslinks between polymer chains. According to an aspect of the present invention, a post-added initiator suitable for reacting with an acrylate, methacrylate, allyl, epoxy, or other functional group on the polymer or oligomer to be grown or cured may be provided. The particular initiator and amount of initiator used depend upon factors known to the person skilled in the art, such as the reaction temperature, the amount and type of solvent (in the case of a solution polymerization), and so on.

The energy used to cause curing may generally be Ultraviolet (UV) in nature, or from another other radiation source. Polymerization in the reactive layer may be performed by reactive polymer or by a reaction of a coupling agent with the reactive polymer or oligomer, monomer and, alternatively, may be cured by the photo-initiated polymerization of the oligomers/monomers in the formulation. The system may use polyester, polyether, polyurethane or polyacrylate as the backbones with the structures but not limited from linear to grafted to hyperbranched to star or even to dendrimer shapes.

The physical properties of the reactive layer can be tailored by using varied mixes to make the desired film. According to an aspect of the invention, the fluid film 220 of the present invention includes at least one oligomer having an aromatic, aliphatic, or mixed aromatic and aliphatic backbone. Upon reaction, the oligomer in the fluid film 220 polymerizes to form a solid film possessing advanced properties with respect to those exhibited by the pure oligomer or the pure polymer. Alternatively, co-reactive oligomer mixes or monomer mixtures may be used instead of a pure oligomer to form cured films that include but are not limited to radom, block copolymers, polymer blends, and the compatible polymer, thereby further achieving a tailoring of properties in the desired film.

Curable species may include free-radically polymerizable or crosslinkable ethylenically-unsaturated species, for example, acrylates, methacrylates, and certain vinyl compounds such as styrenes, and cationically-polymerizable monomers and oligomers and cationically-crosslinkable polymers, for example, epoxies, vinyl ethers, cyanate esters, etc.), and the like, and mixtures.

Suitable free-radically polymerizable species may include mono-, di-, and poly-acrylates and methacrylates (for example, methyl acrylate, methyl methacrylate, ethyl acrylate, isopropyl methacrylate, stearyl acrylate, allyl acrylate, trishydroxyethyl-isocyanurate trimethacrylate, the bis-acrylates and bis-methacrylates of polyethylene glycols of molecular weight about 200-500, glycerol diacrylate, glycerol triacrylate, ethyleneglycol diacrylate, n-hexyl acrylate, diethyleneglycol diacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, triethyleneglycol dimethacrylate, 1,3-propanediol diacrylate, 1,3-propanediol dimethacrylate, bis[1-(2-acryloxy)]-p-ethoxyphenyldimethylmethane, bis[1-(3-acryloxy-2-hydroxy)]-p-propoxyphenyldimethylmethane, copolymerizable mixtures of acrylated monomers, acrylated oligomers; unsaturated amides (for example, methylene bis-acrylamide, methylene bis-methacrylamide, 1,6-hexamethylene bis-acrylamide, diethylene triamine tris-acrylamide and beta-methacrylaminoethyl methacrylate); vinyl compounds (for example, styrene, diallyl phthalate, divinyl succinate, divinyl adipate, and divinyl phthalate); and the like; and mixtures thereof. Reactive polymers include polymers with pendant (meth)acrylate groups. Sarbox™ resins from Sartomer. Other polymers with hydrocarbyl backbone and pendant peptide groups with free-radically polymerizable functionality attached thereto also reactive.

Suitable cationically polymerizable species may include epoxy resins (monomeric epoxy compounds and epoxides of the polymeric type). For example, a diglycidyl ether of a polyoxyalkylene glycol, polybutadiene polyepoxide and a glycidyl methacrylate polymer or copolymer. The epoxides can be pure compounds or can be mixtures of compounds containing one, two, or more epoxy groups on different positions of the backbones. These epoxy-containing materials can vary greatly in the nature of their backbone and substituent groups. The molecular weight of the epoxy-containing materials can vary from about 58 to about 100,000 or more.

Other epoxy materials may contain cyclohexene oxide groups such as epoxycyclohexanecarboxylates, typified by 3,4-epoxycyclohexylmethyl-3,4-epoxycyclohexanecarboxylate, 3,4-epoxy-2-methylcyclohexylmethyl-3,4-epoxy-2-methylcyclohexane carboxylate, and bis(3,4-epoxy-6-methylcyclohexylmethyl)adipate.

Other epoxy-containing materials that may be useful include glycidyl ether monomers. Polymers with epoxy groups pending on the backbone or at the end of the chains are also usable for our applications.

The fluid film 220 may also contain a monomer from about 0.2 to about 8.0% by weight. The monomer may be based on an ester. The functional groups could be in different number (more than 1) with the chemical structure varied from unsaturated ester, acrylate to epoxy, for example. Examples of the polymerizable monofunctional vinyl monomers may include N-vinyl pyrrolidone, N-vinyl caprolactam, vinyl imidazole, and vinyl pyridine; (meth)acrylates containing an alicyclic structure such as isobornyl(meth)acrylate, bornyl(meth)acrylate, tricyclodecanyl(meth)acrylate, dicyclopentanyl(meth)acrylate, dicyclopentenyl(meth)acrylate, and cyclohexyl(meth)acrylate; benzyl(meth)acrylate, 4-butylcyclohexyl(meth)acrylate, acryloylmorpholine, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl(meth)acrylate, isostearyl(meth)acrylate, tetrahydrofurfuryl(meth)acrylate, butoxyethyl(meth)acrylate, ethoxydiethylene glycol(meth)acrylate, benzyl(meth)acrylate, phenoxyethyl(meth)acrylate, polyethylene glycol mono(meth)acrylate, polypropylene glycol mono(meth)acrylate, methoxyethylene glycol(meth)acrylate, ethoxyethyl(meth)acrylate, methoxypolyethylene glycol(meth)acrylate, methoxypropylene glycol(meth)acrylate, diacetone(meth)acrylamide, isobutoxy methyl(meth)acrylamide, N,N-dimethyl(meth)acrylamide, t-octyl(meth)acrylamide, dimethylaminoethyl(meth)acrylate, diethylaminoethyl(meth)acrylate, 7-amino-3,7-dimethyloctyl(meth)acrylate, N,N-diethyl(meth)acrylamide, N,N-dimethyl amino propyl(meth)acrylamide, hydroxy butyl vinyl ether, lauryl vinyl ether, cetyl vinyl ether, 2-ethylhexyl vinyl ether, acrylate monomers.

The fluid film 220 composition may include a photosensitizer from about 0 to about 5.0% by weight per total weight of the composition. The photosensitizer liquid layer may include one-photon or multi-photon photosensitizers. One photon photosensitizer may include ketones, coumarin dyes (for example, ketocoumarins), xanthene dyes, acridine dyes, thiazole dyes, thiazine dyes, oxazine dyes, azine dyes, aminoketone dyes, porphyrins, aromatic polycyclic hydrocarbons, p-substituted aminostyryl ketone compounds, aminotriaryl methanes, merocyanines, squarylium dyes, and pyridinium dyes. Mixtures of photosensitizers may also be utilized. For applications requiring high sensitivity, photosensitizer containing a julolidinyl moiety may be preferred.

Electron donor compounds may be used, optionally, to increase the one-photon photosensitivity of the photoinitiator system. Such electron donor compounds may include amines (including triethanolamine, hydrazine, 1,4-diazabicyclo[2.2.2]octa-ne, triphenylamine (and its triphenylphosphine and triphenylarsine analogs), aminoaldehydes, and aminosilanes), amides (including phosphoramides), ethers (including thioethers), ureas (including thioureas), sulfinic acids and their salts, salts of ferrocyanide, ascorbic acid and its salts, dithiocarbamic acid and its salts, salts of xanthates, salts of ethylene diamine tetraacetic acid, salts of (alkyl).sub.n(aryl).sub.mborates (n+m=4) (tetraalkylammonium salts preferred), various organometallic compounds such as SnR.sub.4 compounds (where each R is independently chosen from among alkyl, aralkyl, aryl, and alkaryl groups), ferrocene, and the like, and mixtures thereof. The electron donor compound may be unsubstituted or may be substituted with one or more non-interfering substituents.

Multiphoton photosensitizers may be multiphoton up-converting inorganic phosphor, for example the phosphor contain optically matched pairs of rare earth ions coordinated within a ceramic host lattice.

The fluid film 220 may also contain from about 0.01 to about 2.0% by weight a photopolymerization initiator. Both free radical and cationic species, by way of non-limiting example, may be used depending on the chemical structure of the reactive functional groups in the system. A brief list of the photoinitiators has been discussed hereinabove. More photoinitiators may include Acetophenone; 2,4,6-Trimethylbenzoyl-diphenyl phosphine; Anisoin; nthraquinone a,a-Dimethoxy-a-hydroxyacetophenone; 2-Methyl-1-(4-methylthio)phenyl-2-morpholino-propan-1-one; 1-Hydroxy-cyclohexylphenylketone; 4-(4-Methylphenylthiophenyl)-phenylmethanone; Phenyltribromomethylsulphone of 2-Isopropyl and 4-Isopropyl thioxanthone; blend of poly{2-hydroxy-2-methyl-1-[4-(1-methylvin-yl)phenyl]propan-1-one), 2,4,6-trimethylbenzoyldiphenylphosphine oxide and methylbenzophenone derivatives; Ethyl 4-(dimethylamino)benzoate; Methyl phenylglyoxylate; Blend of 4-Methylbenzophenone and benzophenone (1:1); Benzil; (Benzene) Hydroxybenzophenone; Camphorquinone; 2,2-Dimethoxy-2-phenylacetophenone; tricarbonylchromium; metallocene salts having an onium cation and a halogen-containing complex anion of a metal or metalloid; iodonium salts and sulfonium salts, as well as metallocene salts having an organometallic complex cation and a halogen-containing complex anion of a metal or metalloid.

The photopolymerization initiator may also include, for example, Irgacure 184 or 369 initiator.

The fluid film 220 may also contain from about 0 to about 2.0% by weight a coupling agent suitable for the purpose of increasing adhesion between the cured material and a material containing the cured material by producing an interaction between both materials. The coupling agent may include a silane, such as, by way of non-limiting example, a methacryloxypropyltris(vinyldimethylsiloxane)silane, methyltris(methylethylketoxime)silane, methyltris(methylisobutylketoxime)silane, methylvinyidi(methylethylketoxime)silane, aminopropyltriethoxysilane, N-.beta.-(aminoethyl)-.gamma.-aminopropyltrimethoxysilane, .gamma.-mercaptopropyltrimethoxysilane, .gamma.-mercaptopropyltriethoxysilane, .gamma.-methacryloxypropyltrimethoxysilane, N-.beta.-(N-vinylbenzylaminoethyl)-.gamma.-aminopropyl-trimethoxysilane hydrochloride, vinyltriacetoxysilane, .gamma.-chloropropyltrimethoxysilane, hexamethyldisilazane, .gamma.-anilinopropyltrimethoxysilane, octadecyidimethyl[3-(trimethoxysilyl)propyl]ammonium chloride, .gamma.-chloropropylmethyldimethoxysilane, .gamma.-mercaptopropylmethyldimethoxysilane, vinyltriethoxysilane, benzyltrimethylsilane, vinyltris(2-methoxyethoxy)silane, .gamma.-methacryloxypropyltris(2-methoxyethoxy)silane, .beta.-(3,4-epoxycyclohexyl)ethyltrimethoxysilane, and n-octyltriethoxysilane.

The fluid film 220 may also contain from about 0.1 to about 6.0% by weight a viscosity regulating agent. The viscosity regulating agent may include a plasticizer, polymeric plasticizer, or polymer. Viscosity regulating agent may include Adipic Acid Derivatives: Dicapryl adipate; Di-(2-ethylhexyl adipate); Azelaic Acid Derivatives: Di(2-ethylhexyl azelate); Di-n-hexyl azelate; Benzoic Acid Derivatives: Diethylene glycol dibenzoate; Dipropylene glycol dibenzoate; Polyethylene glycol 200 dibenzoate; Citric Acid Devivatives: Acetyl tri-n-butyl citrate; Acetyl triethyl citrate; Dimer Acid Derivatives: Bis-(2-hydroxyethyl dimerate); Epoxy Derivatives: Epoxidized linseed oil; Epoxidized soy been oil; Fumaric Acid Derivatives: Dibutyl fumarate; Glyceryl Derivatives: Glyceryl triacetate; Isobutyrate Derivative: 2,2,4-Trimethyl-1,3-pentanediol, diisobutyrate; Isophthalic Acid Derivatives: Dimethyl isophthalate; Diphenyl isophthalate; Lauric Acid Derivatives: Methyl laurate; Linoleic Acid Derivative: Methyl linoleate; Maleic Acid Derivatives: Di-n-butyl maleate; Di(2-ethylhexyl) maleate; Mellitates: Tricapryl trimellitate; Triisodecyl trimellitate; Myristic Acid Derivatives: Isopropyl myristate; Oleic Acid Derivatives: Butyl oleate; Glycerol monooleate; Palmitic Acid Derivatives: Isopropyl palmitate; Methyl palmitate; Paraffin Derivatives: Chloroparaffin, 50% C1; Phosphoric Acid Derivatives: Isodecyl diphenyl phosphate; Tributyl phosphate; Phthalic Acid Derivatives: Butyl benzyl phthalate; Di-n-butyl phthalate; Ricinoleic Acid Derivatives: n-Butyl acetyl ricinloeate; Sebacic Acid Derivatives: Dibutyl sebacate; Stearic Acid Derivatives: Glycerol monostearate; Propylene glycol monostearate; Succinic Acid Derivatives: Diethyl succinate; Sulfonic Acid Derivatives: N-Ethyl o,p-toluenesulfonamide; o,p-toluenesulfonamide; Polymeric: EDENOL 9790; polyacrylic resin and other polymers, by way of non-limiting example only.

The fluid film 220 may also contain from about 0.01 to about 10.0% by weight a release agent. The release agents may include F or Si based compounds. For such Si based compounds, the release agent may include a polyether or polyester and other backbone modified silicone, such as, by way of non-limiting example, a polyester modified polydimethylsiloxane. Other silicones such as silsesquioxane may also be used. In addition, the F based compounds or perfluorinated compounds or polymers may also be used. The release agent could be either non-chemical reactive or chemical reactive or both.

The fluid film 220 may optionally include from about 10.0 to about 99.50% by weight a solvent. The solvent may be, by way of non-limiting example, a chlorobenzene, tetrahydrofuran, ethyl-lactate, N,N′-dimethylformamide, Toluene or Chloroform. For example, chlorobenzene can be present in the liquid layer in amounts as high as 99.5 wt % or slightly lower amounts such as from about 90.5 to 91 wt % or about 90.7 wt % of the composition. In addition to single solvents two or more solvents may also be used in the liquid layer composition. For example, xylene may be present in the range from about 0.25 wt % to 0.3 wt % or in addition to chlorobenzene. All percentages expressed herein are by weight. By “weight %” or “% by weight” is meant part by weight per total weight of liquid layer composition.

According to a first class of preferred embodiments, the composition has a monomer, at least one oligomer and a viscosity controller. The monomer can be, for example, Trimethylolpropanotriacrylate Ester. It can be present in the composition at levels as low as 0.2 wt % and as high as 10 wt %, preferably about 8.0 wt % and more preferably about 3.5-3.7 wt %. The oligomer can be, for example, low viscosity acrylic oligomer ranging from about 0.1-8.0 wt %, preferably from about 0.2-6.0 wt %, more preferably about 1.5 wt %. A second oligomer can be, for example, Methacryloxypropyltris(vinyldimethylsiloxane)silane. It can be present at levels, for example, up to about 5.0 wt %, while a low level of about 0.37 wt % is preferred. A viscosity controller may also be used in the composition. It can range from about 0.1-6.0. A preferred viscosity controller in this embodiment is Polyacrylate. It may be present at levels of about 3.0 wt %. The composition also has a release agent, for example, Polyester modified polydimethylsiloxane from about 0.01-2.0 or from about 0.05 to about 1.0 or about 0.10 wt %. It is preferred to employ a photosensitizer and a photoinitiator. For example, benzophenone can be used in amount ranging from about 0.15 wt % to about 0.20 wt %, preferably from about 0.17 to 0.18 wt %. Similar amounts of a photoinitiator may be added to the composition. Eacure 46 initiator is a preferred photoinitiator. At least one solvent is used as a primary solvent, which can constitute a bulk of the composition. Chlorobenzene can be used as a preferred solvent in amounts ranging from about 90.50-99.5 wt %. A second solvent, if used, forms only a minor part of the overall composition. For example, Xylene can be present in amounts up to about 3.0 wt %.

According to a second class of preferred embodiments, the composition has an oligomer and a surface modifier. The oligomer can be, for example, ethoxylate bisphenol-A dimethacrylate ranging from about 25 wt % to 85 wt %, preferably from about 40 wt % to about 80 wt %. Small amounts of a surface modifier, a photosensitizer and an initiator can also be added to the composition. For example, 2,2,2-trifliuoroethyl methacrylate can be added as a surface modifier. It can be present in the composition at levels as low as 0.2 wt % and as high as 5 wt %, preferably from about 0.5 wt % to about 2 wt % of total weight of the composition. Preferably, benzophenone is used as a photosensitizer and Darocure 1173 is used as a photoinitiator in the composition. For example, benzophenone can be added as a photosensitizer in amounts ranging from about 0.05 wt % to about 5 wt %, preferably from about 0.1 wt % to about 3 wt %. Similar amounts of a photoinitiator may also be added to the composition. Optionally, a monomer, a viscosity controller, and a lubricant may also be added to the composition. For example, lauryl methacrylate can be added in amounts that is up to about 45% or up to about half the amount as the oligomer. A viscosity controller may also be used in the composition. It can be present in the composition up to about 10 wt %. A preferred viscosity controller in this embodiment is diisooctyl phthalate. It may be present at levels of about 3.0 wt %. The composition may also have a lubricant. An example of a release agent used in the composition is polyester modified polydimethylsiloxane. It can be present in amounts from about 0.01-2.0 wt % or from about 0.05 wt % to about 1.0 wt % or about 0.10 wt %. A solvent is also used in the composition. An example of a preferred solvent is toluene. It can be present in amounts from about 1 to about 99 wt %.

According to a third class of preferred embodiments, the composition has an oligomer, a viscosity controller and a surface modifier. The oligomer can be, for example, ethoxylate bisphenol-A dimethacrylate ranging from about 20 wt % to 70 wt %, preferably from about 30 wt % to about 65 wt % and more preferably from about 40 wt % to 60 wt % is used in the composition. An additional oligomer such as, for example, acrylated polyester oligomer may also be used in amounts up to about 10 wt %. A first viscosity controller, for example, Poly(vinyl acetate) ranging from about 20 wt % to 50 wt %, preferably from about 25 wt % to about 40 wt % is also used in the composition. A second viscosity controller, for example, EDENOL 9672 (polymeric plasticizer) may also be added in amounts that is the same as or slightly lower than that of the first viscosity controller. The amount of second viscosity controller, for example, can range from about 1 wt % to about 30 wt %. A surface modifier such as, for example, Poly(dimethylsiloxane)graft Polyacrylate, is also used. It can range from about 1 wt % to about 15 wt %, preferably from about 2 wt % to about 10 wt %. A small amount of an initiator (e.g., Irgacure 184) also be added to the composition. The initiator can be added in amounts, for example, ranging from about 0.01 wt % to about 5 wt %, preferably from about 0.05 wt % to about 3 wt %, more preferably from about 0.1 wt % to about 2 wt %. Optionally, a coinitiator (e.g., amine coinitiator) up to about 1 wt % and a photosensitizer (e.g., benzophenone) up to about 2 wt % are also added to the composition. A solvent (e.g., N,N′-Dimethylformamide) is used in the composition in amounts from about 0 to about 99 wt %.

By way of specific, non-limiting example, a four-inch BK7 glass wafer of approximately 500 microns thickness may be spin coated with a 100-300 nm thick layer of a liquid layer composition of the first class of preferred embodiments described above.

The spin coating may be processed according to procedures known to those possessing an ordinary skill in the pertinent arts, including those set forth above, and additional steps such as baking and chemical cleaning and preparation. For example, after the liquid layer has been spun onto the substrate, the liquid layer/substrate composite may be heated to drive off solvents that were helpful to facilitate spin coating but not needed or undesirable for further processing. For example, the liquid layer/substrate composite may be heated to approximately 115 degrees C. for approximately one to four hours.

Mold 230 may be formed from materials known to those possessing an ordinary skill in the pertinent arts. Such materials include semiconductor materials, including silicon, InP, and GaAs, dielectric materials, including glass, silicon dioxide, polymer materials, including polycarbonate, or metals or metal alloys, including aluminum and nickel by way of non-limiting example only. Mold 230 may be transparent, translucent or opaque to radiation, which radiation may be used to aid in chemical transformation of the liquid layer into a material suitable for maintaining the pattern shape.

The pattern to be fashioned may form a mask layer for lithographic etching, for example. Hence, mold 230 may include recesses or interstices and protrusions that generally correspond to the desired pattern to be etched, and may be inversely related or complimentary of the pattern desired to be formed on substrate 210. That is, as will be understood by those in the pertinent arts, the etched pattern may have deeper interstices or troughs than the molded pattern itself, for example.

The surface of mold 230 may be treated, such as by coating it with a mold release agent, to reduce sticking forces between the mold and liquid layer and the chemically transformed liquid layer, to ease mold 230—film 220 separation, as discussed herein below. Suitable treatments may include siloxane or fluorinated release agents. Such treatments may be additionally applied within or to thin film 220 coated onto substrate 210. By way of specific non-limiting example, mold 230, having a negative of the desired formed pattern, may be surface treated with a mold release agent by solvent dipping, vapor evaporation and plasma based or other chemical vapor deposition, for example. The mold release agent may take the form of commercially available perfluorodecyltrichlorosilane, for example.

Mold 230 may be formed with a negative or complementarily related pattern using standard lithographic and/or other suitable techniques known to those possessing an ordinary skill in the pertinent arts, such as e-beam or holographic interference lithography. One technique that may be utilized may include starting with a silicon wafer having a thickness of approximately 0.5 mm, and then growing silicon dioxide on top of the wafer to a thickness of 150 nm. Recesses, including lines, dots, or other recesses, may be formed by etching into the silicon dioxide such that the recesses have lateral feature sizes of approximately 1 to 900 nm, or 3-300 nm, by way of non-limiting examples only.

Referring still to FIGS. 1 and 2, positioning a mold including the desired pattern in proximity to the liquid layer 130 may include positioning mold 230 near to substrate 210 such that liquid layer 220 is interposed at least partially between the mold and substrate. This positioning may include positioning at least a portion of the mold 230 a substantially uniform distance from liquid layer 220. According to an aspect of the present invention, the distance between the film and mold may generally be in the range of about 50 nm to several microns. According to an aspect of the present invention, this distance may generally be about 100 to 300 nm.

The positioning of mold 230 and substrate 210 may occur at room temperature, although other temperatures such as elevated temperatures may be used. Further, the positioning of the mold 230 and substrate 210 may occur at atmospheric pressure. Further, it should be understood that the positioning need not be precisely controlled, but rather mere placement of the mold in proximity to or in partial contact with portions of the thin film may be sufficient. Of course, precisely controlled placement of the mold is by no means excluded from the scope of the present invention however.

As may be further seen in FIG. 2, and specifically in row B, where the distance between the mold and the liquid layer is small enough, the proximity of the fluid film 210 and mold 230 may cause the liquid layer 220 to self fill the topology of mold 230, and particularly the interstices thereof. While not limiting of the present invention, it is believed interfacial forces, such as capillary forces, may cause parts of the liquid layer to be drawn into, wick into or otherwise enter into grooves, interstices or recesses in the mold. In other words, it is believed this self-filling activity results from forces, such as interfacial forces for example, due to the proximity of the mold 230 and liquid layer 240—as opposed to compressing a softened film between the mold and substrate to force the softened film to conform to the mold.

For purposes of completeness, and as will be understood to those possessing an ordinary skill in the pertinent arts, capillary forces may be defined, generally, to be interfacial forces acting among a liquid and solid in a capillary or in a porous medium. The capillary force may determine the pressure difference (capillary pressure) across a fluid/fluid interface in a capillary or pore. Generally, an interfacial force is a force per unit length, and, as will be understood be known by those possessing an ordinary skill in the pertinent arts, includes forces such as surface tension and friction.

The critical distance represents a distance between the liquid layer and the mold that is sufficiently small such that thin film fluid self fills the mold. If the separation between the mold and the liquid layer exceeds the critical distance, no self filling of the mold will occur. Further, where the mold is not uniformly separated from the liquid layer for any of a number of reasons, if the separation of a portion of the mold and the closest portion of the liquid layer exceeds the critical distance, no self filling of that portion of the mold by the thin film fluid will occur, even though self filling of another portion of the mold may occur. The critical distance results from a number of different criteria, such as 0-200 nm. In the case of the particular formulations for the liquid layer set forth herein, the critical distance may be around 0-100 nm for example.

Non-uniform separation of the mold and liquid layer at the nano-scale may result from any of a number of causes. For example, the mold may simply not be positioned in a level manner with respect to the liquid layer. Further, and as will be understood by those possessing an ordinary skill in the pertinent arts, the surface of the mold and/or liquid layer may not be sufficiently planar at the nano-scale such that the entire mold, or that portion of the mold to be used, may be placed a uniform distance—at the nano-scale—from the liquid layer. That is, in light of the nanoscale features to be reproduced, otherwise insignificant undulations, non-planarities or imperfections in a substrate wafer or mold for example may have significant effects on the critical distances between portions of the substrate and portions of the mold. Thus, even though the mold is placed on top of and in partial contact with the liquid layer for example, portions of the mold may not be in contact with or within the critical distance from the liquid layer after being positioned, as may be desired to promote uniform mold self filling. Rather, portions of the mold may come into contact with portions of the liquid layer while other portions of the mold may remain beyond the critical distance from the film. Further exacerbating this situation, air bubbles may become trapped between the mold and liquid layer that may further serve to reduce the self filling activity.

Referring now also to row C of FIG. 2, a vacuum may be applied to the positioned mold 230 and substrate 210 to promote leveling of mold 230 with respect to substrate 210 to lessen the distance between those portions of the mold and liquid layer that are not within the critical distance. The presence of a vacuum may serve to remove trapped air bubbles between mold 230 and substrate 210 to promote leveling of mold 230 with respect to substrate 210 and reduce those distances between the mold and liquid layer beyond the critical distance self filling threshold. Once air bubbles have been reduced, mold leveling may improve resulting in improved self filling of the mold by the thin film fluid.

For example, the mold and substrate/liquid layer composite may be placed in a deformable container having one or more openings, which container is then subjected to a decrease in pressure, such as by being placed in a vacuum chamber. Such a container may take the form of a deformable plastic bag having one or more openings therein, for example. Such a container may take the form of two PVC plastic sheets forming a quasi-bag that can be vacuumed out, as is set forth below, but that forms a sealed container when a positive pressure relative to its interior is introduced.

According to an aspect of the present invention, the mold 230 and substrate 210 may be placed within the plastic bag allowing its internal space to be evacuated when a vacuum chamber is evacuated, thereby acting to remove residual bubbles and trapped air and promote leveling of the mold with respect to the liquid layer. A vacuum may be held in the chamber for approximately one minute, for example. Vacuum treatment may serve to aid in enhancing pattern replication yield by achieving a more uniform pattern replication, particularly when using substrates of relatively large size and area, such as greater than 1 inch in diameter, for example.

After the mold and liquid layer/substrate composite have been vacuum treated they may optionally be subjected to a relatively low pressure to further promote reduction of distances between parts of the mold and parts of the liquid layer below the critical distance. Such a pressure may range from approximately 14 PSI to about 100 PSI, or even greater, by way of non-limiting example only. For example, the vacuum chamber may have 100 PSI of nitrogen gas rapidly introduced and held for approximately one minute. Where the mold and liquid layer/substrate composite have been placed within a deformable container as has been set forth, such a container may largely serve to prevent introduction of a gas used to provide the applied pressure to the mold/liquid layer/substrate composite structure due to its collapsible nature.

Thereafter, the mold and liquid layer/substrate composite structure may be removed from the vacuum chamber. It should be noted that according to an aspect of the present invention the liquid layer may not yet have been chemically transformed, and hence may not be capable of retaining the mold pattern itself. That is, those skilled in the pertinent arts may recognize that as the film is still fluid in nature, it has not yet and cannot be formed or molded but rather like any fluid merely is a continuous, amorphous substance whose molecules move freely past one another and that has the tendency to assume the shape of its container. Nonetheless, the fluid film may serve to maintain the mold and substrate proximity for some time at room temperature and pressure. For example, the liquid layer may serve to keep the mold and liquid layer/substrate composite in sufficient proximity such that the critical distance remains small enough, such that the liquid layer at least remains partially within mold interstices, recesses or grooves.

While not limiting of the present invention, it is believed interfacial forces due to the proximity of the mold, liquid layer and substrate may serve to hold the mold and liquid layer/substrate composite together for some time, such as minutes, hours, days or even a month or possibly longer, for example, even though the film is not yet formed in the shape of the mold, but rather is merely filling the mold.

Referring still to FIGS. 1 and 2, chemical transformation 140 of the liquid layer may result in solidifying of the liquid layer responsively to the application of ultraviolet radiation or other suitable energy, such as by heating. This irradiation may be applied through the substrate 210, mold 230 or a combination thereof, by way of non-limiting example only. By way of further example only, the mold/liquid layer/substrate composite structure may be subjected to a broad spectrum UV radiating process that delivers approximately a peak power of 1811 Watts/cm², or 10 to 10000 mJ/cm² for about twenty seconds. Ultraviolet light may be applied through the substrate where the substrate is transmissive, or largely transmissive of such radiation, for example, so as to cause an at least partial solidification or curing of liquid layer 220. The chemical transformation may advantageously occur at room temperature and atmospheric pressure, for example, without the need to apply or maintain a high pressure or high temperature until the film hardens.

As will be understood by those possessing an ordinary skill in the pertinent arts, the mechanism used to solidify thin film 220 may depend on the thin film used. Liquid layers and at least one relevant solidifying technique include chemical chain growth, Sol-Gel or UV crosslink processes, for example. The solidifying reaction may include at least one of the following mechanisms: cationic, free radical, or 2+2 phototcycladdition, by way of non-limiting example only.

Thereafter, if the mold/chemically transformed film/substrate sandwich has not been earlier removed from the vacuum bay, it may be. The solidified film may be formed and capable of retaining the mold features, and the mold may be removed from its position near the substrate. This solidification and the following separation are depicted in Row D of FIG. 2. Separation may be facilitated by applying a pressurized air or a pressurized gas stream at a side interface between the mold and solidified liquid layer.

Upon separation 150 of the solidified film 220 from the mold 230, a negative replication of mold 230 in thin film 220 may be revealed. This replicated pattern of the mold may then be used as a mask for etching the substrate 210, if desired. Such a transfer may occur by any suitable method known to those possessing an ordinary skill in the pertinent arts, such as Reactive Ion Etching (RIE), for example.

The replicated pattern may be used for other purposes as well. For example, when a phosphor containing chemical resin suitable for a pixel array is introduced into the liquid layer, the pattern may serve to provide an electro-optical device such as an organic light emitting diode (OLED) structure.

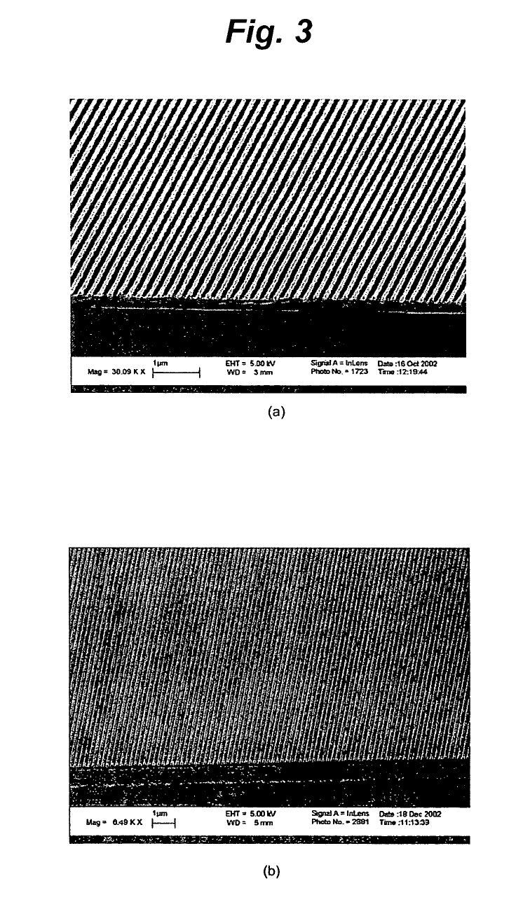

Referring now to FIG. 3, there is shown a pictorial representation of magnified images of gratings formed according to the flow diagram of FIG. 1. As may be seen in view A, a 30,000×-magnification image of grooves formed according to an aspect of the present invention. As may be seen using the 1 μm scale shown therein, FIG. 3 represents grooves with a feature size of approximately 100 nm and a period of 200 nm. The distinct differences in the features and the darkness of the absence of features represent the accuracy and precision achievable according to an aspect of the present invention.

In view B, there is shown a 6,500×-magnification is utilized to show a larger area of the formed grating. Once again the distinct differences of the features and the darkness of the absence of features represent the accuracy and precision of the current technique.

Those of ordinary skill in the art will recognize that many modifications and variations of the present invention may be implemented without departing from the spirit or scope of the invention. Thus, it is intended that the present invention covers the modifications and variations of this invention provided they come within the scope of the appended claims and their equivalents.

1. A method for replicating a nanopattern comprising:
identifying a substrate;
coating a surface of said substrate with a liquid layer;
positioning a mold having a plurality of recesses defining a negative of the nanopattern in sufficient proximity with said coated liquid layer to cause the liquid layer to self-fill at least a portion of said plurality of recesses of said mold; and,
chemically transforming said liquid layer to enable said transformed film to substantially retain said nanopattern.

2. The method of claim 1, wherein said liquid layer has a viscosity suitable for enabling said self-filling to at least partially occur at room temperature and atmospheric pressure.

3. The method of claim 2, further comprising increasing said viscosity of said liquid layer by driving off a solvent after said coating and before said positioning.

4. The method of claim 3, wherein said increasing said viscosity comprises applying heat.

5. The method of claim 1, wherein said identifying comprises selecting a substrate compatible with a telecommunication application.

6. The method of claim 5, wherein said identifying a substrate is at least partially dependent on at least one of optical, mechanical, electrical, business and chemical properties of said substrate.

7. The method of claim 6, wherein said substrate comprises at least one semiconductor.

8. The method of claim 6, wherein said substrate comprises at least one dielectric.

9. The method of claim 6, wherein said substrate comprises at least one metal.

10. The method of claim 6, wherein said substrate comprises at least one plastic.

11. The method of claim 6, wherein said substrate comprises at least one polymer.

12. The method of claim 6, wherein said substrate comprises at least silicon.

13. The method of claim 6, wherein said substrate comprises at least one glass.

14. The method of claim 6, wherein said substrate comprises at least silicon dioxide.

15. The method of claim 6, wherein said substrate comprises at least gallium arsenide.

16. The method of claim 1, wherein said identified substrate comprises a composite substrate.

17. The method of claim 16, wherein said composite substrate comprises InP.

18. The method of claim 16, wherein said composite substrate comprises LiNbO₃.

19. The method of claim 16, wherein said composite substrate comprises garnet.

20. The method of claim 16, wherein said composite substrate comprises SiO₂ and Si.

21. The method of claim 16, wherein said composite substrate comprises Si₃Nₓ and glass.

22. The method of claim 16, wherein said composite substrate comprises a single layer.

23. The method of claim 16, wherein said composite substrate comprises multiple layers.

24. The method of claim 1, wherein said identified substrate is pre-patterned with at least one nanopattern.

25. The method of claim 1, wherein said identified substrate comprises at least one micro-structure.

26. The method of claim 1, wherein said identified substrate comprises a BK7 glass wafer with at least one dielectric thin film.

27. The method of claim 26, wherein said identified substrate is approximately four inches in diameter.

28. The method of claim 26, wherein said identified substrate is approximately six inches in diameter.

29. The method of claim 26, wherein said identified substrate is approximately eight inches in diameter.

30. The method of claim 26, wherein said identified substrate is approximately twelve inches in diameter.

31. The method of claim 26, wherein said identified substrate is approximately 500 microns in total thickness.

32. The method of claim 1, wherein said identified substrate is transparent to radiation suitable for chemically transforming said liquid layer.

33. The method of claim 1, wherein said identified substrate is opaque to radiation suitable for chemically transforming said liquid layer.

34. The method of claim 1, wherein said coating a liquid layer comprises spin coating.

35. The method of claim 34, wherein said spin coating comprises depositing a fluid substantially near the center of said substrate.

36. The method of claim 35, wherein said depositing comprises depositing approximately 1-5 mL of said liquid layer.

37. The method of claim 34, wherein said substrate is spun at approximately 1000-4000 rpm.

38. The method of claim 37, wherein said spinning occurs for approximately 30-60 seconds.

39. The method of claim 1, wherein said liquid layer is coated to a thickness of approximately 50-250 nm.

40. The method of claim 1, wherein said liquid layer is coated with a uniformity of at least approximately +10 nm.

41. The method of claim 1, wherein said liquid layer is coated with a uniformity of at least approximately 3 percent of said liquid layer thickness.

42. The method of claim 1, wherein said liquid layer reduces surface imperfections in said substrate.

43. The method of claim 1, wherein said chemically transformed liquid layer is oxygen etch compliant.

44. The method of claim 1, wherein said liquid layer comprises a polymerizable composite comprising a polymerizable compound and a photointiator, wherein said film is a flowable solution suitable for spin coating onto a surface of said substrate.

45. The method of claim 44, wherein the polymerizable compound comprises an organic and an inorganic composite.

46. The method of claim 45, wherein the organic composite comprises an epoxy, a methyl acrylate, an acrylamide, an acrylic acid, a vinyl, or a ketene acetyl group-containing monomer, oligomer or precursor thereof.

47. The method of claim 45, wherein the inorganic composite comprises silicon, aluminum or a metallic composite.

48. The method of claim 44, wherein the photointiator comprises at least one material selected from the group consisting of free radicals and cations.

49. The method of claim 44, wherein the flowable solution further comprises a viscosity controller.

50. The method of claim 44, wherein the flowable solution further comprises a lubricant.

51. The method of claim 44, wherein the flowable solution further comprises a surface modifier.

52. The method of claim 44, wherein the flowable solution further comprises a coinitiator.

53. The method of claim 52, wherein the coinitiator comprises hydrogen abstraction by an excited initiator.

54. The method of claim 52, wherein the coinitiator comprises photoinduced electron transfer, followed by fragmentation.

55. The method of claim 44, wherein the flowable solution has a viscosity from about 0.001 to 1000 cps.

56. The method of claim 55, wherein the flowable solution has a viscosity from about 0.1 to 1.0 cps.

57. The method of claim 1, wherein said liquid layer comprises a polymerizable component suitable for said liquid layer to retain the shape of said mold after said chemical transformation.

58. The method of claim 1, wherein said liquid layer includes a polymerizable component comprising at least one of aliphatic allyl urethane, nonvolatile materials, aromatic acid methacrylate, aromatic acrylic ester, acrylated polyester oligomer, acrylate monomer, polyethylene glycol dimethacrylate, lauryl methacrylate, aliphatic diacrylate, trifunctional acid ester and epoxy resin.

59. The method of claim 1, wherein said liquid layer comprises a photo-initiator.

60. The method of claim 59, wherein said photoinitiator comprises a free radical.

61. The method of claim 59, wherein said photoinitiator comprises a cationic species.

62. The method of claim 59, wherein said fluid comprises a photosensitizer.

63. The method of claim 59, wherein said photoinitiator comprises at least one of darocure 1173, irgacure 184, irgacure 369, irgacure 907, blend of poly{2-hydroxy-2-methyl-1-[4-(1-methylvin-yl)phenyl]propan-1-one), 2,4,6-trimethylbenzoyldiphenylphosphine oxide and methylbenzophenone derivatives and triarylsulfonium/hexafluoroantimonate salt.

64. The method of claim 1, wherein said liquid layer comprises a viscosity controller.

65. The method of claim 64, wherein said viscosity controller comprises at least one of butyl octyl phthalate, dicapryl phthalate, dicyclohexyl phthalate, diisooctyl phthalate, dimethyl sebacate and polymeric plasticizer and polymer.

66. The method of claim 1, wherein said liquid layer further comprises at least one selected from the group consisting of: internal release agents, compatibilizer, lubricants, coupling agents and other stabilizers.

67. The method of claim 1, wherein said liquid layer further comprises a fluorinated material.

68. The method of claim 1, wherein said liquid layer further comprises a siloxane material.

69. The method of claim 1, wherein said liquid layer comprises a polymerizable component approximately in the range of 0.90-0.99 parts and a photoinitiator approximately in the range of 0.1-0.01 parts.

70. The method of claim 1, wherein said liquid layer comprises a polymerizable component approximately in the range of 0.50-0.99 parts, a photoinitiator approximately in the range of 0.1-0.01 parts, and a viscosity controller approximately in the range of 0.0-0.5 parts.

71. The method of claim 1, wherein said liquid layer comprises a polymerizable component approximately in the range of 0.50-0.99 parts, a photoinitiator approximately in the range of 0.1-0.01 parts, a viscosity controller approximately in the range of 0.0-0.5 parts, and other materials approximately in the range of 0.1-0.01 parts.

72. The method of claim 1, wherein said chemically transforming comprises thermally induced polymerization.

73. The method of claim 72, wherein said thermally induced polymerization produces chain growth on polymer chains.

74. The method of claim 72, wherein said thermally induced polymerization produces crosslinks between polymer chains.

75. The method of claim 1, wherein said chemically transforming comprises photoinitiated polymerization.

76. The method of claim 75, wherein said photoinitiated polymerization produces chain growth on polymer chains.

77. The method of claim 75, wherein said photoinitiated polymerization produces crosslinks between polymer chains.

78. The method of claim 1, wherein said liquid layer comprises a photosensitizer.

79. The method of claim 78, wherein said photosensitizer comprises about 0 to about 2% of the total weight of said liquid layer.

80. The method of claim 78, wherein said photosensitizer comprises a ketone.

81. The method of claim 80, wherein said ketone comprises benzophenone.

82. The method of claim 81, wherein said benzophenone comprises about 0.15% by weight of said liquid layer.

83. The method of claim 1, wherein said liquid layer comprises a photopolymerization initiator.

84. The method of claim 83, wherein said photopolymerization initiator comprises Irgacure 184.

85. The method of claim 83, wherein said photopolymerization initiator comprises a irgacure 369 initiator.

86. The method of claim 83, wherein said photopolymerization initiator comprises about 0.01 to about 2.0 percent weight of said liquid layer.

87. The method of claim 1, wherein said liquid layer comprises a coupling agent.

88. The method of claim 87, wherein said coupling agent comprises a silane.

89. The method of claim 88, wherein said silane comprises at least one of a methacryloxypropyltris(vinyldimethylsiloxane)silane, tetramethoxysilane, tetraethoxysilane, methyltrimethoxysilane, methyltris(methylethylketoxime)silane, methyltris(methylisobutylketoxime)silane, methylvinyldi(methylethylketoxime)silane, aminopropyltriethoxysilane, tridecafluoro-1,1,2,2,-tetrahydro-octyltriethoxysilane, N-.beta.-(aminoethyl)-.gamma.-aminopropyltrimethoxysilane, N-.beta.-(aminoethyl)-.gamma.-aminopropyltriethoxysilane, N-bis[.beta.-(aminoethyl)]-.gamma.-aminopropylmethyldimethoxysilane, .gamma.-mercaptopropyltrimethoxysilane, .gamma.-mercaptopropyltriethoxysilane, .gamma.-methacryloxypropyltrimethoxysilane, N-.beta.-(N-vinylbenzylaminoethyl)-.gamma.-aminopropyl-trimethoxysilane hydrochloride, methyltrimethoxysilane, methyltriethoxysilane, vinyltriacetoxysilane, .gamma.-chloropropyltrimethoxysilane, hexamethyldisilazane, .gamma.-anilinopropyltrimethoxysilane, vinyltrimethoxysilane, octadecyldimethyl[3-(trimethoxysilyl)propyl]ammonium chloride, .gamma.-chloropropylmethyldimethoxysilane, .gamma.-mercaptopropylmethyldimethoxysilane, methyltrichlorosilane, dimethyldichlorosilane, trimethylchlorosilane, vinyltriethoxysilane, benzyltrimethylsilane, vinyltris(2-methoxyethoxy)silane, .gamma.-methacryloxypropyltris(2-methoxyethoxy)silane, .beta.-(3,4-epoxycyclohexyl)ethyltrimethoxysilane, .gamma.-ureidopropyltriethoxysilane, .gamma.-isocyanurpropyltriethoxysilane, and n-octyltriethoxysilane.

90. The method of claim 87, wherein said coupling agent comprises about 0 to about 5 percent by weight of said liquid layer.

91. The method of claim 1, wherein said liquid layer comprises a viscosity regulating agent.

92. The method of claim 91, wherein said viscosity regulating agent comprises about 0.1 to about 6.0 percent by weight of said liquid layer.

93. The method of claim 91, wherein said viscosity regulating agent comprises at least one of a plasticizer, polymeric plasticizer, and polymer.

94. The method of claim 93, wherein said polymer comprises a polyacrylate.

95. The method of claim 1, wherein said liquid layer comprises a release agent.

96. The method of claim 95, wherein said release agent comprises about 0.01 to about 10.0% by weight of said liquid layer.

97. The method of claim 95, wherein said release agent comprises at least one of a polyether, polyester, and other backbone modified silicone.

98. The method of claim 97, wherein said release agent comprises a polyester modified polydimethylsiloxane.

99. The method of claim 95, wherein said release agent is non-chemical reactive.

100. The method of claim 95, wherein said release agent is chemical reactive.

101. The method of claim 1, wherein said liquid layer comprises a monomer.

102. The method of claim 101, wherein said monomer comprises about 0.2 to about 8.0% by weight of said liquid layer.

103. The method of claim 101, wherein said monomer comprises at least one of an ester or a polymer backbone.

104. The method of claim 103, wherein said ester comprises a trimethylolpropanotriacrylate ester.

105. The method of claim 103, wherein said polymer backbone comprises at least one of a polyether, polyurethane and polyamide.

106. The method of claim 1, wherein said liquid layer comprises a solvent.

107. The method of claim 106, wherein said solvent comprises about 10.0 to about 99.50% by weight of said liquid layer.

108. The method of claim 106, wherein said solvent comprises at least one of a chlorobenzene, tetrahydrofuran, ethyl-lactate, N,N′-dimethylformamide, Toluene or Chloroform.

109. The method of claim 1, wherein said mold comprises at least one of semiconductor materials, dielectric materials, polymer materials, metals and metal alloys.

110. The method of claim 109, wherein said semiconductor materials comprises at least one of silicon, silicon carbide, silicon nitride, InP, and GaAs.

111. The method of Clam 109, wherein said dielectric materials comprises at least one of glass and silicon dioxide.

112. The method of claim 109, wherein said polymer material comprises a polycarbonate.

113. The method of claim 109, wherein said metal alloy comprises at least one of aluminum and nickel.

114. The method of claim 109, wherein said mold is transparent to radiation.

115. The method of claim 114, wherein said radiation aids in chemically transforming said liquid layer.

116. The method of claim 109, wherein said mold is opaque to radiation.

117. The method of claim 116, wherein said radiation aids in chemically transforming said liquid layer.

118. The method of claim 1, wherein a surface of said mold is treated with a release agent suitable to reduce sticking forces between said mold and said liquid layer.

119. The method of claim 118, wherein said release agent comprises at least one of siloxane and fluorinated release agents.

120. The method of claim 118, wherein said mold is treated with at least one of solvent dipping, vapor evaporation and plasma based chemical vapor deposition and chemical vapor deposition

121. The method of claim 118, wherein said release agent comprises perfluorodecyltrichlorosilane.

122. The method of claim 1, wherein said liquid layer is substantially interposed between said mold and said substrate by said positioning.

123. The method of claim 1, wherein said positioning comprises positioning said mold a substantially uniform distance from said substrate.

124. The method of claim 123, wherein said uniform distance is in the range of approximately 50 nm to microns.

125. The method of claim 124, wherein said uniform distance is in the range of approximately 100 to 300 nm.

126. The method of claim 1, wherein said positioning comprises placement of said mold in at least partial contact with at least a portion of said liquid layer.

127. The method of claim 1, where said positioning comprises controlled placement of said mold.

128. The method of claim 1, wherein said self-filling occurs at least in part as a result of interfacial forces exerted on said liquid layer resulting from said positioning.

129. The method of claim 1, further comprising inputting a post-added initiator suitable for reacting with an acrylate, methacrylate, allyl, or epoxy.

130. The method of claim 1, wherein said chemically transforming comprises irradiating said liquid layer.

131. The method of claim 130, wherein said irradiating comprises applying ultraviolet radiation.

132. The method of claim 130, wherein said ultraviolet radiation is delivered with a peak power approximately in the range of 10 to 10000 mJ/cm² for about twenty seconds.

133. The method of claim 130, wherein said chemically transforming comprises heating.

134. The method of claim 133, wherein said liquid layer comprises at least one solvent, and said coating further comprises heating said liquid layer to substantially drive off solvents.

135. The method of claim 134, wherein said liquid layer comprises at least one solvent, and said coating further comprises chemical cleaning of said liquid layer.

136. The method of claim 134, wherein said heating comprises heating to approximately 115 C for a time in the range of approximately one to four hours.

137. The method of claim 1, further comprising evacuating said volume between said positioned mold and said substrate suitable to promote leveling of said mold with respect to said substrate.

138. The method of claim 137, wherein said evacuating serves to remove trapped air bubbles between said mold and said substrate.

139. The method of claim 137, wherein said evacuating comprises placing said mold and said substrate in a deformable container having one or more openings, wherein said container is subjected to at least partial vacuum.

140. The method of claim 139, wherein said decrease in pressure comprises placing said container in a vacuum chamber.

141. The method of claim 139, wherein said deformable container comprises at least one PVC plastic sheet forming a quasi-bag.

142. The method of claim 139, wherein said evacuating occurs for approximately one minute.

143. The method of claim 1, further comprising transferring said nanopattern included in said transformed mold into said substrate.

144. The method of claim 143, wherein said transferring comprises reactive ion etching.

145. A device created by a method for replicating a nanopattern, said method comprising:
coating a surface of a substrate with a liquid layer;
positioning a mold having a plurality of recesses defining a negative of the nanopattern in sufficient proximity with said coated liquid layer to cause the liquid layer to self-fill at least a portion of said plurality of recesses of said mold; and,
chemically transforming said liquid layer to enable said transformed film to substantially retain said nanopattern.

146. The device of claim 145, wherein said liquid layer comprises a phosphor containing chemical resin suitable for a pixeled array.

147. The device of claim 146, wherein said nanopattern serves to provide an electro-optical device.

148. The device of claim 147, wherein said electro-optical device comprises an organic light emitting diode.

149. A method for replicating a nanopattern on a substrate comprising:
coating the surface of the substrate with a fluid film;
positioning a mold including a pattern corresponding to the nanopattern in sufficient proximity with said coated fluid film to cause the fluid film to self-fill to at least a portion of said mold;
transforming said fluid film such that said transformed fluid film at least partially retains the nanopattern; and,
separating said transformed mold and the surface.

150. A system for replicating a nanopattern on a substrate comprising:
a fluid film;
a means for coating the surface of the substrate with said fluid film;
a mold including a pattern indicative of the nanopattern and being positionable in sufficient proximity with said coated fluid film to cause the fluid film to self-fill to at least a portion of said mold;
a means for transforming said fluid film such that said transformed fluid film at least partially retains the nanopattern; and,
a means for separating said transformed mold and the surface.

151. A chemically transformed liquid layer composition suitable for forming a thin layer on a surface, said layer comprising:
a polymerizable composite comprising a polymerizable compound and a photointiator, wherein the composition is a flowable solution for spin coating a surface of a substrate and wherein the composition is susceptible to transformation into a material for maintaining a pattern shape of a mold.

152. The composition of claim 151, wherein the polymerizable compound comprises an organic and an inorganic composite.

154. The composition of claim 152, wherein the organic composite comprises an epoxy, a methyl acrylate, an acrylamide, an acrylic acid, a vinyl, or a ketene acetyl group-containing monomer, oligomer or precursor thereof.

155. The composition of claim 151, wherein the inorganic composite comprises silicon, aluminum or a metallic composite.

156. The composition of claim 151, wherein the photointiator is at least one selected from the group consisting of: eacure 46, darocure 1173, irgacure 184, irgacure 369, and hexafluoroantimonate or a salt thereof.

156. The composition of claim 151, wherein the flowable solution further comprises a viscosity controller.

157. The composition of claim 151, wherein the flowable solution further comprises a lubricant.

158. The composition of claim 151, wherein the flowable solution further comprises a surface modifier.

159. The composition of claim 151, wherein the flowable solution further comprises a coinitiator.

160. The composition of claim 159, wherein the coinitiator comprises hydrogen abstraction by the excited initiator.

161. The composition of claim 159, wherein the coinitiator comprises photoinduced electron transfer, followed by fragmentation.

162. The composition of claim 151, wherein the flowable solution has a viscosity from about 0.001 cps to 100 cps.

163. The composition of claim 151, further comprising an additive.

164. A device having a surface coated with the composition of claim 151.
